(19) United States
(12) Patent Application Publication
(10) Pub. No.: US 2002/0167692 A1
(43) Pub. Date: Nov. 14, 2002

(54) Method of manufacturing a security item

(75) Inventor: Karen Cunningham, Bucks (GB)

Correspondence Address: OLIFF & BERRIDGE, PLC, P.O. BOX 19928, ALEXANDRIA, VA, 22320, US

(73) Assignee: DE LA RUE INTERNATIONAL LIMITED, Hampshire (GB)

(21) Appl. No.: 09/851,997

(22) Filed: May 10, 2001

(51) Int. Cl. G02B 5/30; B29D 11/00

(52) U.S. Cl. 359/2; 264/1.31

(57) ABSTRACT

A method of manufacturing a security item comprises casting a polymer plastics substrate. During the casting process, a security material such as a thread is supplied which is embedded in the substrate.

The invention relates to a method of manufacturing a security item such as a security document or card carrying security indicia.

Plastic cards have been in use for many years. Typically, there have been two types. The first, used mainly for financial cards, is made of PVC. A white PVC core is printed with the decoration or security indicia. The core can be composed either of one sheet with printing on both sides or two sheets with the front decoration printed on one, the reverse on the other. A clear laminate film is applied front and back and the three or four layer “sandwich” is then put in a press between highly polished metal plates, and under heat and pressure the layers fuse together. The process is highly labour intensive and energy inefficient. The pressing process introduces distortions which result in sophisticated registration equipment being needed to ensure that each card is diecut in the correct position. The presence of printing ink between the core and the laminate usually has an adverse effect on the bonding of the laminate. This can result in a risk of delamination and reduces the resistance of the card to flexing stress.

The resulting cards have proved acceptable for financial cards where the life is in the order of two years. They are much less successful where a long life, of say 10 years, is needed as the PVC tends to go brittle and crack with age. Personalisation of financial PVC-based cards usually involves the embossing of personalisation data, which introduces stresses into the card structure which can have an adverse effect on card life. PVC is now viewed with disfavour for environmental reasons. To overcome the deficiencies of PVC, cards of polyester and polycarbonate have been introduced. These are much more expensive, require lamination at higher temperatures and are in consequence even less energy efficient. Only certain grades of these polymers yield cards that can be embossed. However, it is only the financial card market that requires embossing; for many other applications, such as identity cards, alternative personalisation techniques that do not require embossing are becoming employed.

JP-A-8-290539 describes a polyester multi-layer film suitable for magnetic cards and in particular for pin ball cards. In particular, a laminated polyester film formed from joint extrusion laminated biaxial oriented polyester film is described, the film having a layer containing white pigments on at least the outermost layer of one side and at least one layer containing fluorescent light emitting particles. Cards of the type described in this prior art document are used for transit tickets and so on and typically have a thickness of the order of 250 microns. They are typically decorated by printing on the surface.

US-A-5830561 discloses an ID card formed by laminating together a number of coextruded polypropylene layers. This is disadvantageous in view of the number of different steps involved in the manufacturing process.

Where a card is to be used as an identity card, a range of personal information relating to the holder needs to be applied to the card. In addition to textual items such as the name and date of birth, a portrait of the holder, possibly accompanied by a biometric identifier such as a fingerprint, is required. Such personal data has to be resistant to fraudulent attack since its alteration could enable the card to be used by someone other than the cardholder. For many years, identity cards of the so-called “pouche” type have been used. In this, a piece of security printed paper with an attached photograph is sealed into a clear pouch, the pouch consisting of a folded piece of clear plastic heat seal bonded around the edges. Typically, these can survive for 10 years. However, they are falling out of favour as they lack the clean appearance of a PVC card and cannot readily conform to international standards for magnetic or smart cards. The clear heat seal plastic laminate film used in this type of card is typically formed of a biaxially oriented polyester with an adhesion promoting layer. This layer may be applied by extrusion coating or by coextrusion of a high melting point polyester with a low melting point polyester followed by biaxial orientation.

In accordance with the present invention, a method of manufacturing a security item comprises a casting polymer plastics substrate and, during the casting process, supplying a security material which is embedded in the substrate.

This method produces a security item which in very difficult to separate and thus fraudulently alter.

In some preferred aspects, the polymer plastics is non-biaxially oriented. Although biaxial orientation gives some strength to thin films, it also has the effect of pulling the molecules together so that it is particularly difficult to get certain marking materials, particularly subliming dyes, to penetrate between them.

The security material and polymer plastics are preferably supplied to a release substrate at substantially the same location in the casting process. However, it would be possible to supply the security material downstream of the point at which the polymer plastics material is supplied.

The security material can take a variety of forms. For example, in some cases, the security material will comprise a security thread. The thread can be constructed in any conventional form and may include, for example, an optically variable structure such as a diffraction grating or hologram and/or be at least partially metallised on one surface. Any other conventional banknote-style thread could be used.

The thread may also be formed by the use of a microextruder immediately before delivering it. In this form the thread is typically formed of the preferred substrate material together with appropriate security additives as indicated below. The heat from the molten polymer causes sufficient softening of the thread material to ensure fusion between the thread and the plastics substrate.

In other examples, the security material comprises an additive or a coloured polymer, preferably such an additive is machine detectable. For example, a fluorescent material can be included so that if any attempt to modify the item is made, this will become apparent when an attempt is made to validate the item by attempting to generate the fluorescence. Usually, the fluorescence will not be visible under optical irradiation so that it provides covert security.

Other security additives which could be used include optically variable materials, magnetic materials, laser writable materials, anti-stokes materials, thermochromic materials, phosphorescent materials, ir readable materials, photochromic materials and chemical raggants. More than one of these could be used and/or different types e.g. different colours of the same material. A further possibility is to include a material in the form of particles or fibres whose distribution in an individual piece of plastic can be determined by a suitable detection system. This can form the basis of a machine verification system permitting every card to be uniquely identifiable. For example, the distribution which is determined can then be stored as security data elsewhere on the item.

More than one additive, coloured polymer or thread could be added to the substrate by adding them at suitable locations spaced across the lateral dimension of the substrate.

The invention has a number of advantages including the fact that no laminations or adhesives are required. In general, security printing is also not required since the security features are already embedded in the product. The cast process generates a constant thickness product which can therefore be produced in roll format. However, security indicia may also be provided on the substrate either directly or indirectly on a further layer secured to the substrate.

The currently preferred approach is to print the security indicia onto a carrier such as paper using one or more inks incorporating sublimable dye(s). The carrier is then brought into contact with a surface of the substrate and heated to cause the dye(s) to sublime, transfer to the substrate and diffuse into the substrate. In another approach, the security indicia could be printed directly onto the substrate itself using inks with or without sublimable dyes. In a further alternative, inks containing sublimable dye(s) could be printed directly onto the substrate followed by the application of heat to cause the dye(s) to diffuse into the substrate.

The security item could be used simply with the security indicia, for example as an item of currency. The invention is particularly concerned, however, with the production of identification cards and the like, the method further comprising providing personalised indicia on the substrate relating to the bearer of the security item. Conveniently, the personalised indicia is provided in a similar manner to the security indicia. Thus, the personalised indicia may be printed onto a carrier such as paper using an ink jet printer or the like with an ink containing one or more sublimable dyes. These dyes are then caused to transfer and diffuse into the substrate using the same method as using the security indicia. Other techniques as described above in connection with the security indicia could also be used to provide the personalised indicia.

In addition, one or both of the security indicia and personalised indicia could be provided by a laser writing technique if the plastic substrate is provided with a laser writable additive.

Examples of suitable polymer plastics materials include polybutylene terephthalate (PBT) and alloys thereof, polycarbonate, polypropylene, PU, PVC and PET.

The invention is particularly suited for manufacturing items with thicknesses of 30-200 microns.

The invention is generally applicable to banknotes, cheques (whether bank or travellers), bonds, share certificates, licences, some types of identity cards, smart cards, passports, visas tickets, passbooks, vouchers, deeds, tamper revealing seals and labels, brand authenticity labels and the like. Indeed, any security item based on a plastics material could be implemented using this invention. Of course, where a flexible item is required, such as a banknote, then suitable plastics materials should be chosen, for example polypropylene.

Some examples of methods according to the invention will now be described with reference to the accompanying drawings, in which:

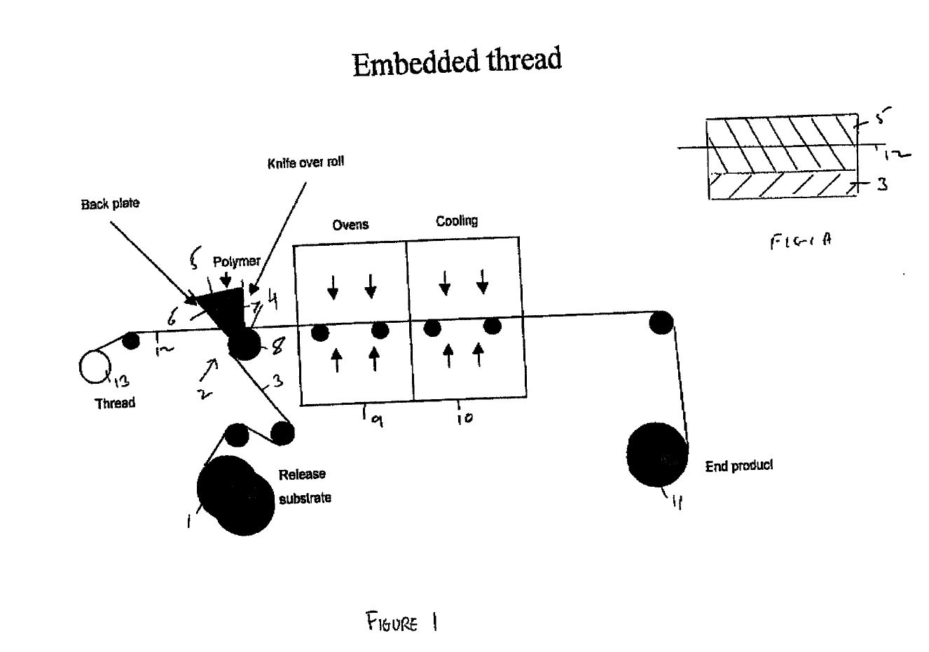

FIG. 1 is a schematic view of a casting process utilizing a security thread,

FIG. 1A being a cross-section through the finished product (not to scale);

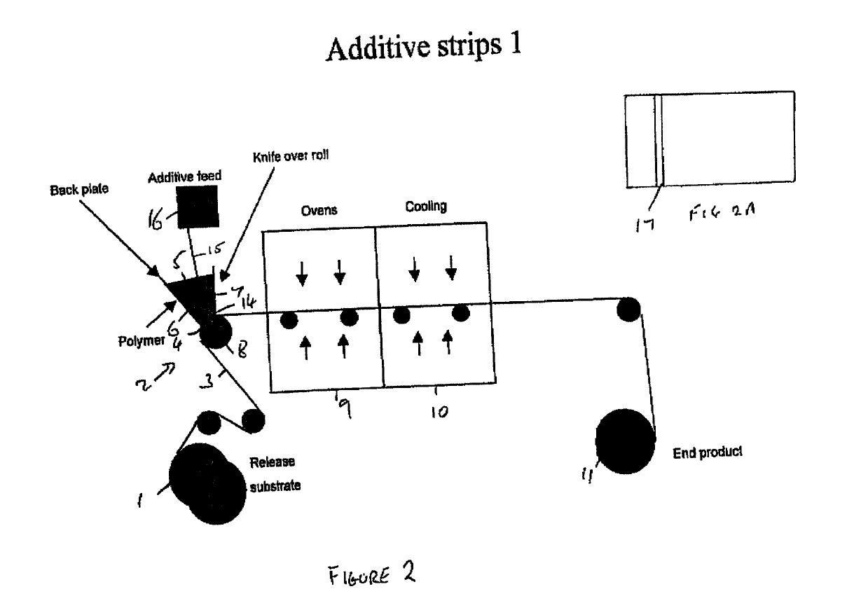

FIG. 2 is a view similar to FIG. 1 but illustrating the inclusion of an additive or coloured polymer,

FIG. 2A being a plan of the finished product;

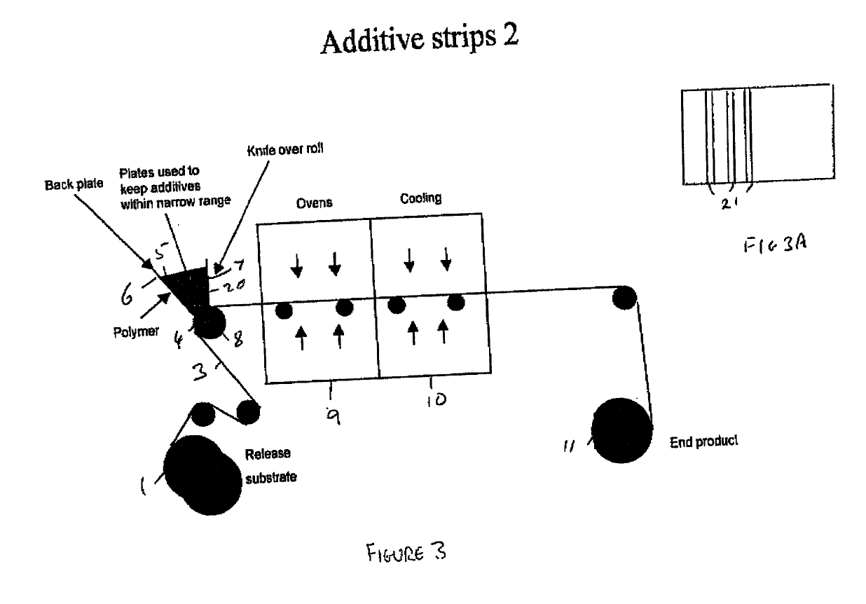

FIG. 3 is a view similar to FIG. 1 but illustrating an alternative process for adding an additive or coloured polymer,

FIG. 3A being a plan of the finished product; and,

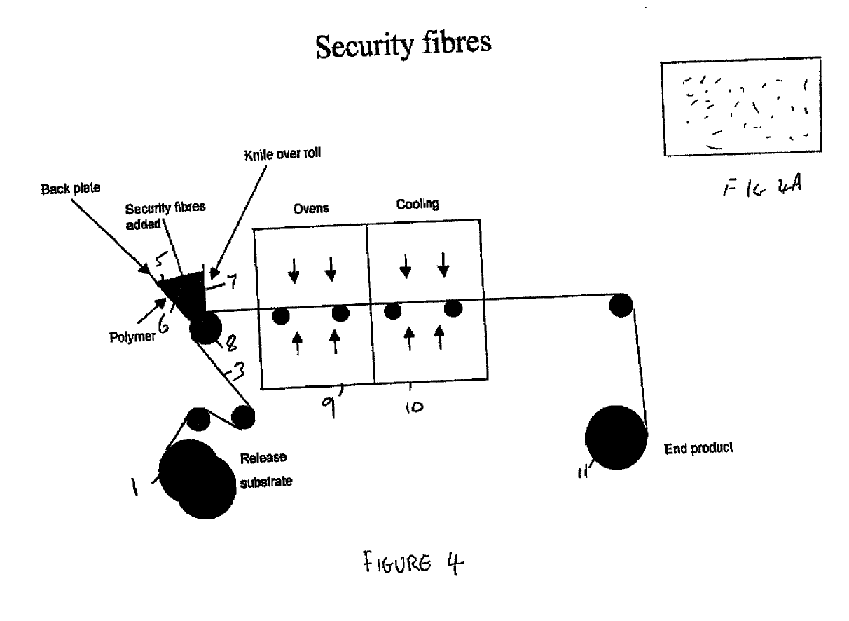

FIG. 4 is a view similar to FIG. 1 but illustrating the addition of security fibres,

FIG. 4A being a plan of the finished product.

The casting system shown in FIG. 1 comprises a release substrate roll 1 from which a release substrate such as siliconized paper is unwound and passed to a casting station 2 where a plastics polymer such as PBT is cast onto the substrate 3 through a nozzle 4. The nozzle 4 is formed at the base of a reservoir 5 defined by a backplate 6 and a leading knife member 7. The knife member 7 cooperates with an underlying roll 8 to define a gap through which the cast polymer is carried on the release substrate 3. The cast polymer is then carried through ovens 9 and a cooling system 10 to cure the polymer and then the end product is wound onto a take-up roll 11. The cast material could be separated from the release substrate before winding but will usually remain in place, particularly for thin films.

The system so far described is conventional. In this example of the invention, a security thread 12 is supplied from a roll 13 through the nozzle 4 so that it becomes embedded in the polymer plastics layer cast onto the substrate 3. It is important to control the angle at which the thread enters the nozzle to ensure it remains embedded.

The end product shown in FIG. 1A thus comprises the release substrate 3 carrying the cast, cured plastics polymer 5 with the thread 12 embedded in it.

In the remaining examples, those items which are the same as in FIG. 1 will be given the same reference numerals and not further described.

In the FIG. 2 example, instead of a thread, an additive is introduced into the polymer as it is cast onto the release substrate 3. The additive is supplied through a fine nozzle 14 coupled with a supply line 15 through which the additive is pumped by a pump 36. The resulting product can be seen in plan form in FIG. 2A with the additive in the form of a security strip shown at 17.

FIG. 3 illustrates a modification of the FIG. 2 example. In this case, a set of three laterally spaced security strips are produced using the same or different additives. This is achieved by providing a set of dividers 20 in the polymer reservoir so that the additives are supplied through the nozzle at corresponding lateral positions. The resulting product is shown in FIG. 3A with the individual strips indicated at 21. In practice, the strips will not be perfectly defined as shown in the drawing but some lateral mixing will occur to produce a rainbow effect. This makes the product particularly difficult to counterfeit.

In the FIG. 4 example, the polymer reservoir is divided into two laterally spaced sections by a pair of dividers (not shown) which themselves define a further reservoir therebetween into which the fibres or additives suspended in polymer can be supplied. The resultant product (FIG. 4A) has the fibres randomly distributed.

One of the advantages of this invention is that it is not essential to provide additional security printing since the security features which have been added provide sufficient security. However, in some cases, the finished product could be supplied to a printing station for transferring further security indicia and/or personalized indicia onto the substrate. This will not be described in detail since it will be well understood by a person of ordinary skill in the art.

It would be possible to vary the concentration of additives in the lateral direction which firstly achieves additional security but secondly enables bar code features to be generated.

1. A method of manufacturing a security item, the method comprising casting a polymer plastics substrate and, during the casting process, supplying a security material which is embedded in the substrate.

2. A method according to claim 1, wherein the security material and the polymer plastics are supplied to a release substrate at substantially the same location in the casting process.

3. A method according to claim 1, wherein the security material is supplied upstream of heating and cooling stations.

4. A method according to claim 1, wherein the security material comprises a thread.

5. A method according to claim 4, wherein the thread defines an optically variable structure such as a diffraction grating or hologram.

6. A method according to claim 4, wherein the thread is at least partially metallised on one surface.

7. A method according to claim 1, wherein the security material comprises an additive or coloured polymer.

8. A method according to claim 7, wherein the security material is pumped through a nozzle.

9. A method according to claim 7, wherein the security material is supplied through part of a nozzle used to supply the polymer plastics.

10. A method according to claim 7, wherein the security material comprises more than one additive or coloured polymer, each additive or coloured polymer being supplied at laterally spaced apart positions.

11. A method according to claim 7, wherein the security additive is machine detectable.

12. A method according to claim 7, wherein the security additive includes at least one of a fluorescent material, an optically variable material, a magnetic material, a laser writable material and an anti-strokes material.

13. A method according to claim 1, wherein the security material comprises security fibres.

14. A method according to any of the preceding claims, wherein the plastics materials is one of polybutylene terephthalate (PBT) and alloys thereof, polycarbonate, polypropylene, PU, PVC and PET.

15. A method according to any of the preceding claims, wherein the security item has a thickness not less than 400 microns.

16. A method according to claim 1, further comprising providing security indicia on the substrate.

17. A method according to claim 16, wherein the security indicia are provided using one or more sublimable dyes, the method further comprising causing the dye(s) to diffuse into the substrate.

18. A method according to claim 17, wherein the sublimable dye(s) are contained within an ink or toner.

19. A method according to claim 17, wherein the security indicia are provided on a carrier, the carrier is brought into contact with the substrate, and the dye(s) are then caused to transfer from the carrier and diffuse into the substrate.

20. A method according to claim 16, wherein the security indicia are printed on the substrate by a gravure, offset lithographic, intaglio, letterpress or flexographic printing process.

21. A method according to claim 1, further comprising providing personalised indicia on the substrate relating to the bearer of the security item.

22. A method according to claim 21, wherein the personalised indicia are provided on a carrier using sublimable dye(s), the carrier is brought into contact with the substrate, and the dye(s) are then caused to transfer from the carrier and diffuse into the substrate.

23. A security item manufactured by a method according to claim 1.
